(19) United States
(12) Patent Application Publication
(10) Pub. No.: US 2019/0141738 A1
(43) Pub. Date: May 9, 2019

(54) WIRELESS COMMUNICATION APPARATUS AND ANTENNA FILTERING METHOD

(71) Applicant: Fujitsu Limited, Kawasaki-shi (JP)

(72) Inventor: Ryuichi Namba, Kawasaki (JP)

(73) Assignee: Fujitsu Limited, Kawasaki-shi (JP)

(21) Appl. No.: 16/180,810

(22) Filed: Nov. 5, 2018

(30) Foreign Application Priority Data
Nov. 9, 2017 (JP) 2017-216192

(51) Int. Cl. H04W 72/14; H04B 7/0404; H04W 72/06

(52) U.S. Cl. CPC H04W 72/14; H04W 72/06; H04B 7/0404

(57) ABSTRACT

There is provided a wireless communication apparatus including a radio unit configured to receive a radio signal transmitted from a terminal apparatus and convert the received radio signal into a baseband signal, a memory, and a processor coupled to the memory and the processor configured to determine a number of layers of the terminal apparatus according to request throughput of the terminal apparatus included in the baseband signal, within a range of maximum throughput in a transmission path between the radio unit and a baseband processing unit configured to include the memory and the processor, and generate an instruction signal for indicating an antenna port used in a wireless communication with the terminal apparatus, based on the number of layers, wherein the radio unit performs antenna filtering of the baseband signal transmitted from the terminal apparatus according to the instruction signal.

### CROSS-REFERENCE TO RELATED APPLICATION

This application is based upon and claims the benefit of priority of the prior Japanese Patent Application No. 2017-216192, filed on Nov. 9, 2017, the entire contents of which are incorporated herein by reference.

### FIELD

The embodiments discussed herein are related to a wireless communication apparatus and an antenna filtering method.

### BACKGROUND

Currently, the 3rd Generation Partnership Project (3GPP), which is a standard group, is considering a 5th generation mobile communication (hereinafter, may be referred to as “5G”) as a next-generation wireless communication system technology. In 5G, as a continuous development of the Long Term Evolution (LTE) system or an LTE-Advanced system, or as a new radio access technology (RAT) for supporting a broad carrying area using a higher frequency band than ever, for example, a “New Radio,” has been examined.

In 5G, gNB (next generation Node B) is being considered as a base station that supports the “New Radio.” In the gNB, a central unit (CU) and a distributed unit (DU) are provided, and one or a plurality of DUs is connected to one CU. For example, the CU is a logical node that controls the DU, and the DU is a logical node that is controlled by the CU.

Further, in 3GPP, it is being examined where the function of each of the CU and the DU is to be split (function split).

As one of the options by the examination, there is a plan called option 7-1. Option 7-1 is a plan that allows the DU to have the fast Fourier transform (FFT) and cyclic prefix (CP) removal and a physical random access channel (PRACH) filtering function, and allows the CU to have other physical (PHY) functions, with respect to an uplink (UL). It is being examined that the PRACH filtering function also has, for example, a function of a combination or selection of the antenna data.

Further, there is also a plan called option 7-2. Option 7-2 is a plan that allows the DU to have the FFT, the CP removal, a resource mapping, a pre-filtering function, and the CU to have other physical functions, in an uplink direction. It is also being examined that the pre-filtering function has, for example, a function to compress received data from the number of antenna ports to the number of user streams based on the channel information.

Meanwhile, a base station (evolved Node B (eNB)) in an LTE system or an LTE-Advanced system may include a baseband unit (BBU) and a radio unit (remote radio head (RRH)). In this case, the BBU and the RRH are connected to each other by, for example, an optical fiber, and an interface called a common public radio interface (CPRI) is used. A space between the BBU and the RRH may be called front haul (FH), and a space between the BBU and a core network (CN) may be called back haul (BH).

For example, a technology relating to such a wireless communication system will be described below. That is, there is a wireless network in which at least one control device determines an allocation of a base station transmission resource to a terminal from the base station based on a rate which the base station may provide to the terminal and a transmission resource which the base station provides to the terminal.

According to such a technology, a load balancing (e.g., a load distribution) of the entire network becomes possible.

Further, there is a user device that determines an antenna port according to the position of an N-th control channel element and receives a control channel transmitted from the base station by using the determined antenna port in a search space corresponding to an aggregation level of a set of candidate control channels.

According to such a technology, the user device may guarantee correctly demodulating and receiving the control channel or control channel element transmitted by the base station.

Related techniques are disclosed in, for example, Japanese Laid-open Patent Publication No. 2016-005280, and Japanese National Publication of International Patent Application No. 2015-510374.

Related techniques are also disclosed in, for example, 3GPP TR 38.801 V14.0.0 (2017-03), and 3GPP TSG RAN WG3 Meeting NR AH#2, R3-1702287, “Further details on option 7,” Intel Corporation, Qingdao, China, 27th to 29th, Jun. 2017.

### SUMMARY

According to an aspect of the embodiments, a wireless communication apparatus includes a radio unit configured to receive a radio signal transmitted from a terminal apparatus and convert the received radio signal into a baseband signal, a memory, and a processor coupled to the memory and the processor configured to determine a number of layers of the terminal apparatus according to request throughput of the terminal apparatus included in the baseband signal, within a range of maximum throughput in a transmission path between the radio unit and a baseband processing unit configured to include the memory and the processor, and generate an instruction signal for indicating an antenna port used in a wireless communication with the terminal apparatus, based on the number of layers, wherein the radio unit performs antenna filtering of the baseband signal transmitted from the terminal apparatus according to the instruction signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a communication system;

FIG. 2 is a diagram illustrating an example of a configuration of a base station apparatus;

FIG. 3 is a diagram illustrating an example of a configuration of a terminal apparatus;

FIG. 4 is a diagram illustrating an example of a hardware configuration of the base station apparatus;

FIG. 5 is a diagram illustrating an example of a hardware configuration of the terminal apparatus;

FIG. 6 is a diagram illustrating an example of antenna filtering;

FIG. 7 is a diagram illustrating an example of antenna filtering;

FIG. 8 is a diagram illustrating an example of antenna filtering;

FIG. 9 is a flowchart illustrating an operation example of a BBU;

FIG. 10 is a flowchart illustrating an operation example of an antenna port priority determination processing;

FIG. 11 is a flowchart illustrating an operation example of an antenna filtering setting processing;

FIG. 12 is a flowchart illustrating an operation example of a transmission layer number change processing;

FIGS. 13A to 13C are diagrams illustrating an example of a numerical value;

FIG. 14 is a diagram illustrating an example of a configuration of a wireless communication system;

FIG. 15 is a diagram illustrating an example of a configuration of a wireless communication system; and

FIG. 16 is a diagram illustrating an example of a configuration of a wireless communication system.

### DESCRIPTION OF EMBODIMENTS

Due to the recent increase in mobile traffic, the throughput of the front hall (FH) is also increasing. In response to such an increase in throughput, when an optical fiber is extensively installed between a base band unit (BBU) and a remote radio head (RRH), cost will increase. Meanwhile, when such extensive installation may not be performed, a base station apparatus may not output data from the RRH to the BBU or may not output data from the BBU to the RRH according to requested throughput from the terminal apparatus.

A technique for determining the allocation of a base station transmission resource from the base station to the terminal by at least one control device described above does not suggest any countermeasure for increasing the throughput of the FH in, for example, the base station. Further, a technique that determines an antenna port according to the position of the control channel element does not suggest any countermeasure for increasing the throughput of the FH in, for example, the base station.

Therefore, in any technology, there are cases where it is not possible to prevent the increase in throughput in the FH or to perform the transmission according to the throughput requested from the terminal. For this reason, in any technology, the FH may not be used efficiently.

Hereinafter, embodiments of a technology capable of efficiently using a transmission path between a radio section and a baseband processing unit will be described. Further, the embodiments described below do not limit the present disclosure. In addition, the respective embodiments may be appropriately combined with each other within the scope that does not cause any inconsistency in processing contents. Further, as terms or technical contents described in this specification, terms or technical contents described in a specification may be appropriately used as a standard such as third generation partnership project (3GPP).

### First Embodiment

### [Example of Configuration of Wireless Communication System]

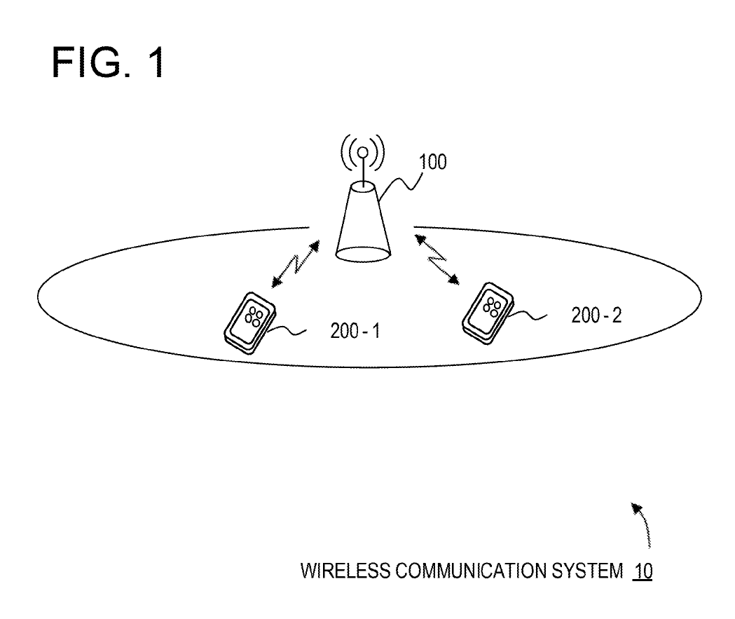

FIG. 1 is a diagram illustrating an example of a configuration of a wireless communication system 10 in a first embodiment.

The wireless communication system 10 includes a base station apparatus (hereinafter, may be referred to as “base station”) 100 and terminal apparatuses (hereinafter, may be referred to as “terminals”) 200-1 and 200-2.

The base station 100 is, for example, a wireless communication apparatus capable of wirelessly communicating with the terminals 200-1 and 200-2. The base station 100 may provide various services such as a call service and a Web browsing service to the terminals 200-1 and 200-2 located in a service available range (or cell range) of the base station 100.

The terminal 200 is, for example, a wireless communication apparatus capable of wirelessly communicating with the terminal 100. The terminal 200 is, for example, a smart phone, a feature phone, a tablet terminal, a game device, or a clock device capable of performing a wireless communication.

Further, in the example of FIG. 1, an example is illustrated in which the two terminals 200-1 and 200-2 are connected to one base station 100, but one terminal 200-1 may be connected to one base station 100 or three or more terminals 200-1, 200-2 may be connected to one base station 100. In addition, as for the base station 100, not only one base station 100 but also a plurality of base stations may be installed.

Further, in the following description, since the terminals 200-1 and 200-2 have the same configuration, the terminal 200 will be described unless particularly specified.

### [Example of Configuration of Base Station Apparatus]

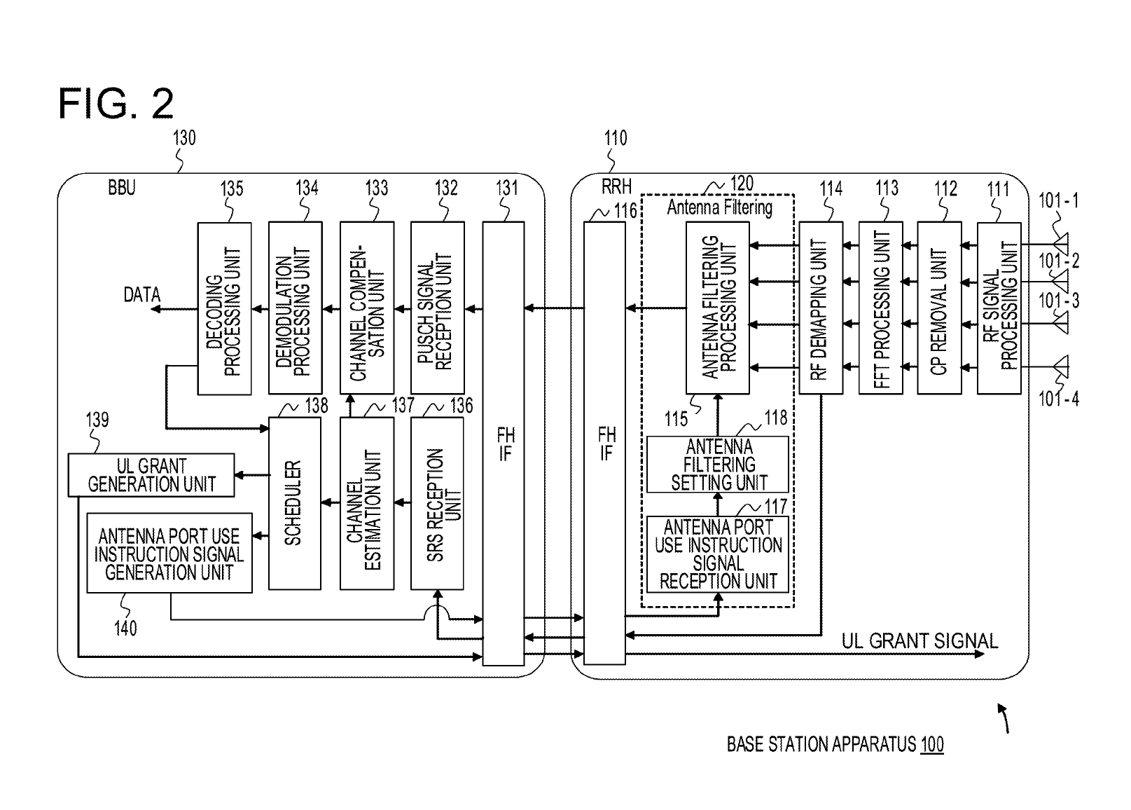

FIG. 2 is a diagram illustrating an example of a configuration of the base station 100.

The base station 100 includes four antennas 101-1 to 101-4, an RRH 110, and a BBU 130.

For example, the RRH 110 receives a radio signal transmitted from the terminal 200 and converts the received radio signal into a baseband signal. The RRH 110 may be referred to as, for example, a radio unit.

The RRH 110 includes a radio frequency (RF) signal processing unit 111, a cyclic prefix (CP) removal unit 112, an FFT processing unit 113, and a resource element (RE) demapping unit 114. Further, the RRH 110 includes an antenna filtering processing unit 115, a front haul interface (FHIF) 116, an antenna port use instruction signal reception unit 117, and an antenna filtering setting unit 118. In addition, the antenna filtering 120 includes an antenna filtering processing unit 115, an antenna port use instruction signal reception unit 117, and an antenna filtering setting unit 118.

For example, the BBU 130 receives a baseband signal from the RRH 110 and performs a processing for the received baseband signal. The BBU 130 may be referred to as, for example, a baseband processing unit.

The BBU 130 includes an FHIF 131, a physical uplink shared channel (PUSCH) signal reception unit 132, a channel compensation unit 133, a demodulation processing unit 134, and a decoding processing unit 135. Further, the BBU 130 includes a sounding reference signal (SRS) reception unit 136, a channel estimation unit 137, a scheduler 138, an uplink (UL) grant generation unit 139, and an antenna port use instruction signal generation unit 140.

The antennas 101-1 to 101-4 receive the radio signal transmitted from the terminal 200 and output the received radio signal to the RF signal processing unit 111.

The RF signal processing unit 111 converts a radio signal (or RF signal) in a radio band into a baseband signal in a baseband band. Therefore, the RF signal processing unit 111 may internally include, for example, a frequency conversion circuit or an analogue to digital (A/D) conversion circuit.

The CP removal unit 112 removes a CP added to the baseband signal from the baseband signal output from the RF signal processing unit 111. The CP removal unit 112 outputs the baseband signal from which the CP has been removed, to the FFT processing unit 113.

The FFT processing unit 113 performs an FFT processing (or fast Fourier transform processing) with respect to the baseband signal to convert the baseband signal in a time domain into the baseband signal in a frequency domain. The FFT processing unit 113 outputs the baseband signal after the conversion, to the RE demapping unit 114.

The RE demapping unit 114 returns a subcarrier signal mapped to each resource element to a multiplexed signal for the baseband signal (or subcarrier signal) converted into the frequency domain. Then, the RE demapping unit 114 extracts (or demultiplexes) a PUSCH signal or an SRS (or reference signal) from the multiplexed signal, and outputs the PUSCH signal to the antenna filtering processing unit 115 and the SRS to the FHIF 116.

The antenna filtering processing unit 115 performs antenna filtering for each terminal 200 with respect to the baseband signal transmitted from the terminal 200 according to instruction information output from the antenna filtering setting unit 118.

For example, as the instruction information for terminal 200-1, it is instructed to enable antenna ports #1 to #4 to be effective as follows. That is, the antenna filtering processing unit 115 validates the antenna ports #1 to #4 with respect to the data transmitted from the terminal 200-1 and outputs the PUSCH signal output from the antennas 101-1 to 101-4 to the FH.

Further, for example, as the instruction information for terminal 200-2, it is instructed to enable the antenna port #1 to be validated and the other antenna ports #2 to #4 not to be validated as follows. That is, the antenna filtering processing unit 115 validates the antenna port #1 with respect to the data transmitted from the terminal 200-2 and outputs the PUSCH signal output from the antenna 101-1 to the FH. In this case, the antenna filtering processing unit 115 does not validate the antenna ports #2 to #4, and for example, discards the PUSCH signal output from the antennas 101-2 to 101-4 without outputting the PUSCH signal to the FH.

For example, since the antenna filtering processing unit 115 knows the portion of an input end where the physical connection lines of the antennas 101-1 to 101-4 (or antenna ports #1 to #4) are connected, it is possible to set a valid antenna port based on the instruction information.

Further, in the following description, the antennas 101-1 to 101-4 and the antenna ports #1 to #4 may be used without distinction.

The FHIF 116 generates, for example, packet data including the PUSCH signal output from the antenna filtering processing unit 115 or the SRS output from the RE demapping unit 114, and transmits the generated packet data to the BBU 130. The packet data is, for example, packet data according to an interface transmitted to the FH. An example of such an interface is CPRI.

Further, the FHIF 116 receives the packet data transmitted from the BBU 130 and extracts the antenna port use instruction signal and an up link (UL) grant signal from the received packet data. The FHIF 116 outputs the extracted antenna port use instruction signal to the antenna port use instruction signal reception unit 117, and transmits the UL grant signal to the terminal 200 using a communication path in a down link (DL) direction.

The antenna port use instruction signal reception unit 117 receives the antenna port use instruction signal transmitted from the BBU 130 via the FHIF 116. The antenna port use instruction signal reception unit 117 outputs the received antenna port use instruction signal to the antenna filtering setting unit 118.

Based on the antenna port use instruction signal, the antenna filtering setting unit 118 generates indication information indicating which antenna port of the antenna ports #1 to #4 is to be validated for each of the terminals 200-1 to 200-3, and outputs the generated indication information to the antenna filtering processing unit 115.

The FHIF 131 of the BBU 130 receives the packet data transmitted from the RRH 110 and extracts, for example, the PUSCH signal (or baseband signal) or SRS from the received packet data. The FHIF 131 outputs the extracted PUSCH signal to the PUSCH signal reception unit 132 and outputs the SRS to the SRS reception unit 136. Further, upon receiving the antenna port use instruction signal from the antenna port use instruction signal generation unit 140, the FHIF 131 generates the packet data including the received antenna port use instruction signal and transmits the generated packet data to the RRH 110. In addition, the FHIF 131 generates packet data including the UL grant signal output from the UL grant generation unit 139 and transmits the generated packet data to the RRH 110.

Upon receiving the PUSCH signal, the PUSCH signal reception unit 132 outputs the received PUSCH signal to the channel compensation unit 133.

The channel compensation unit 133 performs, for example, a reception processing (e.g., a processing of returning rotation of a phase generated by transmission to an original transmission state) by channel compensation on the PUSCH signal using a channel estimation value from the channel estimation unit 137.

The demodulation processing unit 134 performs a demodulation processing on a channel-compensated PUSCH signal and generates a demodulation signal. The demodulation processing unit 134 outputs the generated demodulation signal to the decoding processing unit 135.

The decoding processing unit 135 performs an error correction decoding processing on the demodulation signal and extracts for example, data or a scheduling request signal from the demodulation signal. The decoding processing unit 135 outputs the data to another processing unit and outputs the scheduling request signal to the scheduler 138.

The SRS reception unit 136 outputs the SRS (or reference signal) received from the FHIF 131, to the channel estimation unit 137.

The channel estimation unit 137 calculates a channel estimation value based on the SRS and outputs the calculated channel estimation value to the channel compensation unit 133. Further, the channel estimation unit 137 measures (or estimates) a communication quality (or a channel state (channel quality indicator (CQI) or channel state information (CSI)) between the terminal 200 and the base station 100 from the calculated channel estimation value and outputs the measured value to the scheduler 138 as channel information. The channel information includes, for example, a received power value of the SRS for each user (or each radio resource block) and a signal to interference ratio (SIR).

For example, upon receiving the scheduling request signal transmitted from the terminal 200, the scheduler 138 performs an uplink scheduling based on, for example, the channel information output from the channel estimation unit 137. The scheduler 138 outputs a scheduling result to the UL grant generation unit 139.

Further, the scheduler 138 determines the number of layers of the terminal 200 according to request throughput of the terminal 200 included in the scheduling request signal (or baseband signal) within a range of maximum throughput in a transmission path between the BBU 130 and the RRH 110. The scheduler 138 outputs the determined number of layers to the antenna port use instruction signal generation unit 140. The number of layers corresponds to, for example, the number of transmission streams when the terminal 200 transmits data to the base station 100. Details of the process of determining the number of layers will be described in the operation example.

The UL grant generation unit 139 generates a UL grant signal including the scheduling result and outputs the generated UL grant signal to the FHIF 131.

The antenna port use instruction signal generation unit 140 generates an antenna port use instruction signal indicating an antenna port to be used (or valid) for the wireless communication with the terminal 200 based on, for example, the number of layers. The antenna port use instruction signal generation unit 140 transmits the generated antenna port use instruction signal to the RRH 110 via the FHIF 131. Details will be described in the example of operation. [Configuration Example of Terminal Apparatus]

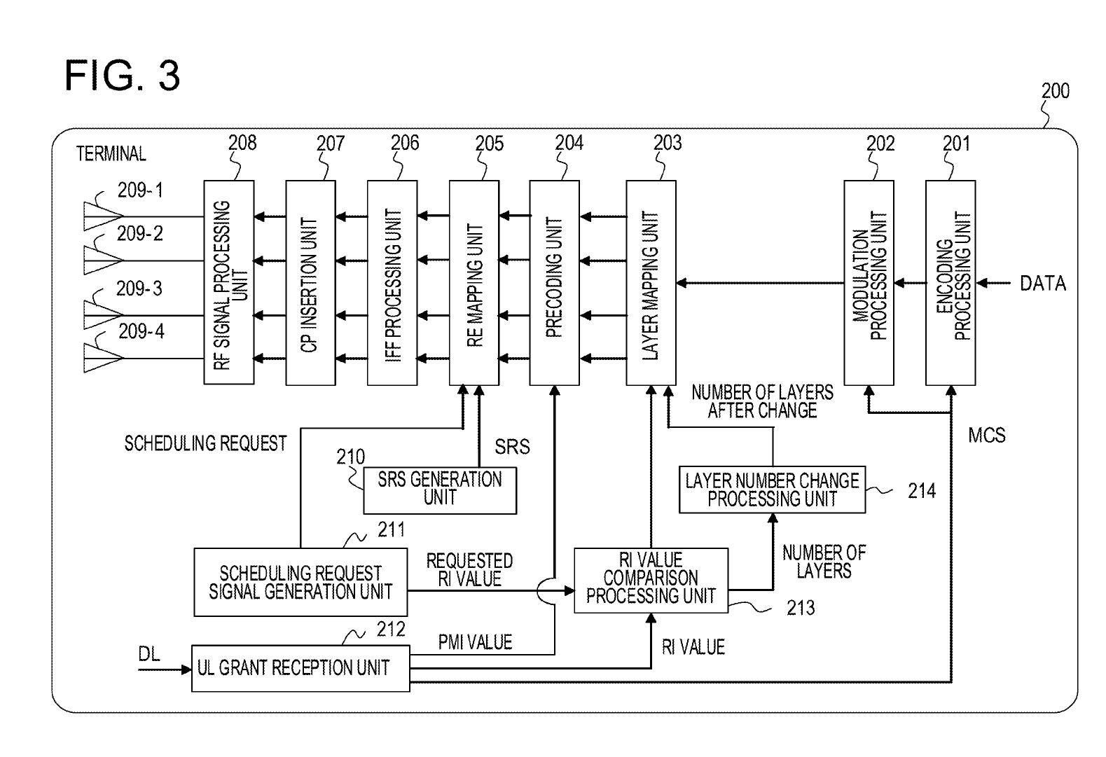

FIG. 3 is a diagram illustrating an example of a configuration of a terminal 200.

The terminal 200 includes an encoding processing unit 201, a modulation processing unit 202, a layer mapping unit 203, a precoding unit 204, an RE mapping unit 205, an inverse FFT (IFFT) processing unit 206, a CP insertion unit 207, an RF signal processing unit 208, and antennas 209-1 to 209-4. Further, the terminal 200 includes an SRS generation unit 210, a scheduling request signal generation unit 211, a UL grant reception unit 212, an RI value comparison processing unit 213, and a layer number change processing unit 214.

The encoding processing unit 201 performs an error correction coding processing on data with a predetermined coding rate according to a modulation channel coding scheme (MCS) output from the UL grant reception unit 212, and generates an encoding signal. The encoding processing unit 201 outputs the generated encoding signal to the modulation processing unit 202.

The modulation processing unit 202 performs a modulation processing on the encoding signal by a predetermined modulation scheme according to the MCS output from the UL grant reception unit 212, and generates the modulation signal. The modulation processing unit 202 outputs the generated modulation signal to the layer mapping unit 203.

The layer mapping unit 203 maps the modulation signal to each layer according to the number of layers received from the RI value comparison processing unit 213 or the number of layers after the change received from the layer number change processing unit 214. The number of layers also corresponds to the number of antennas 209-1 to 209-4 used, for example, when the modulation signal (data signal) is transmitted. In the example of FIG. 3, the maximum number of layers is 4.″ In the example of FIG. 3, an example is illustrated, in which the layer mapping unit 203 maps the modulation signals to the four antennas 209-1 to 209-4.

The precoding unit 204 selects a precoding matrix based on, for example, a precoding matrix indicator (PMI) value output from the UL grant reception unit 212 and weights each modulation signal according to the selected precoding matrix. The precoding unit 204 outputs the weighted modulation signal to the RE mapping unit 2.

The RE mapping unit 205 maps the weighted modulation signal, the SRS output from the SRS generation unit 210, and the scheduling request signal output from the scheduling request signal generation unit 211, to a predetermined resource element (RE) (or subcarrier mapping is performed). In this case, the scheduling result for the terminal 200 is included in the UL grant signal received by the UL grant reception unit 212. Therefore, the RE mapping unit 205 maps the data signal (modulation signal) or the scheduling request to the PUSCH region by using, for example, the scheduling result. Further, the RE mapping unit 205 maps the SRS to, for example, a predetermined resource element.

The IFFT processing unit 206 performs an inverse fast Fourier transform processing (IFFT processing) on the output signal from the RE mapping unit 205, and converts the output signal in the frequency domain into the output signal in the time domain.

The CP insertion unit 207 inserts (or adds) the CP into the output signal and outputs the output signal with the CP inserted therein to the RF signal processing unit 208.

The RF signal processing unit 208 converts the output signal in the baseband band into a radio signal (or RF signal) in the radio band, and outputs the converted radio signal to the antennas 209-1 to 209-4. Therefore, the RF signal processing unit 208 may include, for example, a digital to analog (D/A) conversion circuit or a frequency conversion circuit.

The antennas 209-1 to 209-4 transmit the radio signals to the base station 100.

The SRS generation unit 210 generates the SRS (or reference signal) and outputs the generated SRS to the RE mapping unit 205. The SRS may be, for example, a known signal sequence.

The scheduling request signal generation unit 211 generates a scheduling request including a rank indicator (RI) value, and transmits the generated scheduling request to the RE mapping unit 205 and the RI value (or requested RI value) to the RI value comparison processing unit 213, respectively. For example, the scheduling request signal generation unit 211 may generate the scheduling request or the RI value based on the reference signal transmitted from the base station 100.

The UL grant reception unit 212 receives the UL grant transmitted from the base station 100 by using a communication link in the DL direction. The UL grant reception unit 212 extracts the MCS, the RI value, and the PMI value from the received UL grant, and outputs the extracted MCS to the encoding processing unit 201 and the modulation processing unit 202, the extracted RI value to the RI value comparison processing unit 213, and the extracted PMI value to the precoding unit 204, respectively.

The RI value comparison processing unit 213 compares the requested RI value with the RI value included in the UL grant, and when both the requested RI value and the RI value are the same value, the RI value comparison processing unit 213 outputs the number of layers, which corresponds to the requested RI value (or the RI value included in the UL grant) to the layer mapping unit 203. Further, the RI value and the number of layers may be, for example, the same value. Meanwhile, when the requested RI value and the RI value included in the UL grant are different from each other, the RI value comparison processing unit 213 outputs both the requested RI value and the RI value to the layer number change processing unit 214.

The layer number change processing unit 214 changes the requested RI value to the RI value included in the UL grant and outputs the number of layers corresponding to the changed RI value to the layer mapping unit 203 as the number of layers after the change.

Therefore, when the requested RI value and the RI value allocated to the base station 100 are the same as each other, the layer mapping unit 203 receives the number of layers corresponding to the RI value from the RI value comparison processing unit 213. Meanwhile, when the requested RI value and the RI value allocated to the base station 100 are different from each other, the layer mapping unit 203 receives the number of layers corresponding to the allocated RI value from the layer number change processing unit 214.

### [Example of Hardware Configuration]

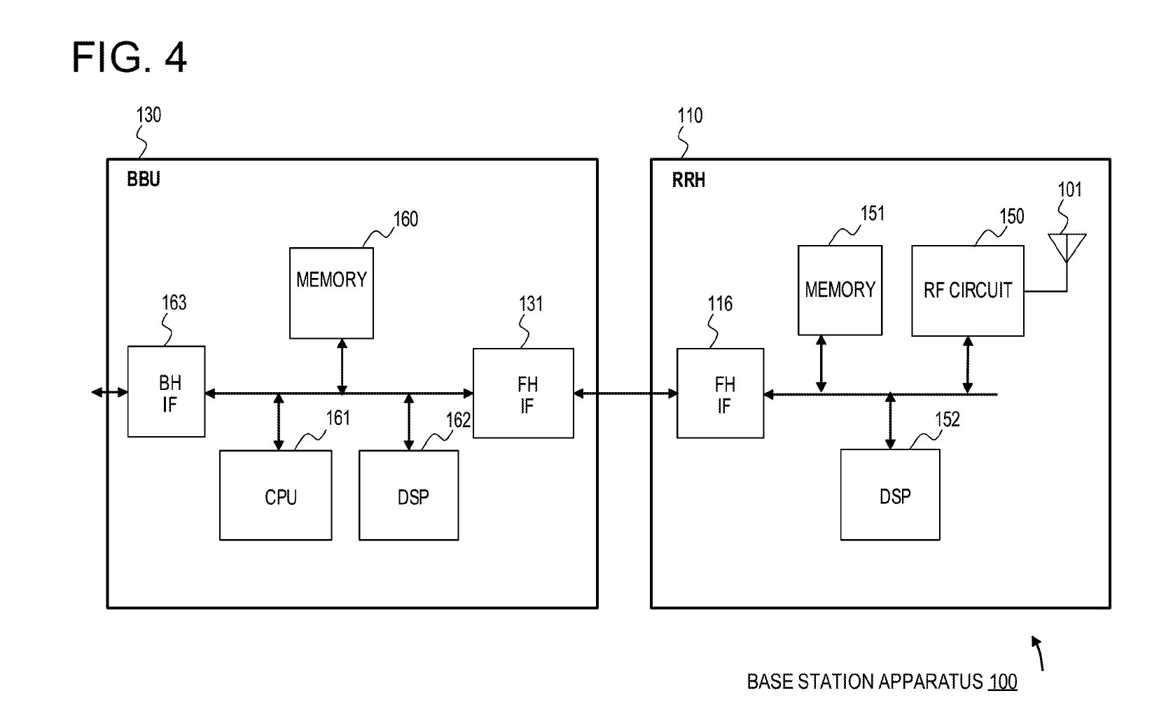

FIG. 4 is a diagram illustrating an example of a hardware configuration of a base station 100.

The RRH 110 further includes an RF circuit 150, a memory 151, and a digital signal processor (DSP) 152. In addition, the BBU 130 includes a memory 160, a CPU 161, a DSP 162, and a back haul interface (BHIF) 163.

For example, the RF circuit 150 corresponds to the RF signal processing unit 111. Further, the DSP 152 corresponds to, for example, the CP removal unit 112, the FFT processing unit 113, the RE demapping unit 114, or the antenna filtering 120. The memory 151 is used as a working memory, for example, when a processing is performed in the DSP 152.

In addition, the CPU 161 implements the functions of the scheduler 138, the UL grant generation unit 139, and the antenna port use instruction signal generation unit 140 by, for example, reading and executing a program stored in the memory 160. The CPU 161 corresponds to, for example, the scheduler 138, the UL grant generation unit 139, or the antenna port use instruction signal generation unit 140.

Further, the DSP 162 corresponds to, for example, the PUSCH signal reception unit 132, the channel compensation unit 133, the demodulation processing unit 134, the decoding processing unit 135, the SRS reception unit 136, or the channel estimation unit 137. In addition, the memory 160 is used as a working memory, for example, when processing is performed in the CPU 161 or the DSP 162.

For example, upon receiving the data from the CPU 161, the BHIF 163 generates packet data including the received data and transmits the generated packet data to the core network using the BH. Further, for example, the BHIF 163 may extract, for example, the data from the packet data received from the core network via the BH and output the data to the CPU 161.

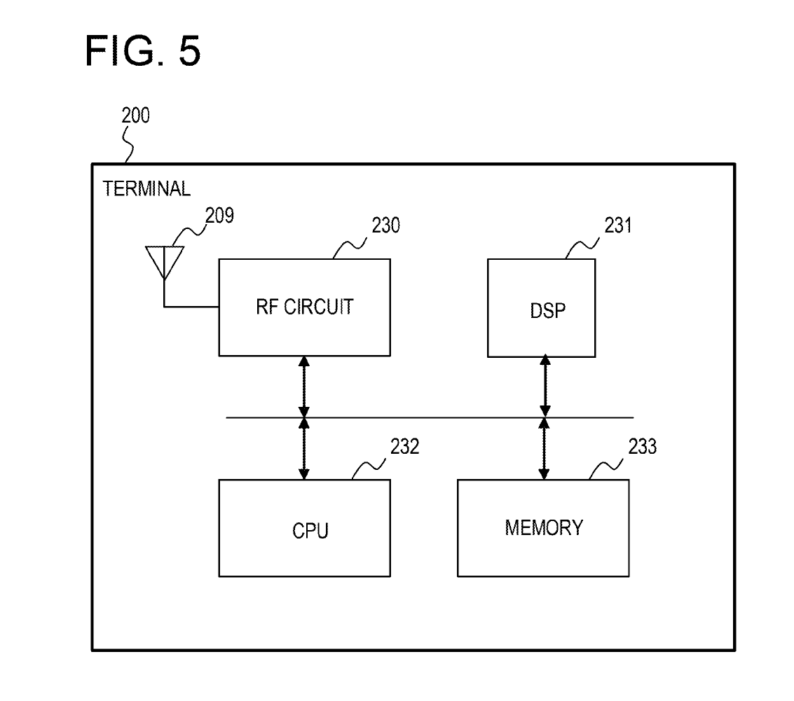

FIG. 5 is a diagram illustrating an example of a hardware configuration of a terminal 200.

The terminal 200 further includes an RF circuit 230, a DSP 231, a CPU 232, and a memory 233. The CPU 232 implements the functions of a scheduling request signal generation unit 211, a UL grant reception unit 212, an RI value comparison processing unit 213, and a layer number change processing unit 214 by, for example, reading and executing the program stored in the memory 233. The CPU 232 corresponds to, for example, the scheduling request signal generation unit 211, the UL grant reception unit 214, the RI value comparison processing unit 213, or the layer number change processing unit 214.

Further, the DSP 231 corresponds to, for example, the encoding processing unit 201, the modulation processing unit 202, the layer mapping unit 203, the precoding unit 204, the RE mapping unit 205, the IFFT processing unit 206, the CP insertion unit 207, or the RF signal processing unit 208.

In addition, the memory 233 is used as the working memory, for example, when a processing is performed in the CPU 232 or the DSP 231.

Further, the two CPUs 161 and 232 may be, for example, processors and controllers such as a micro processing unit (MPU), a field programmable gate array (FPGA), or a DSP, in place of the CPU.

### [Operation Example]

First, as for the antenna filtering, an example of uniformly performing the antenna filtering will be described, and then, an example of performing the antenna filtering for each terminal 200 will be described. In addition, a detailed operation example in the first embodiment is described.

### 1. Example of Uniformly Performing Antenna Filtering

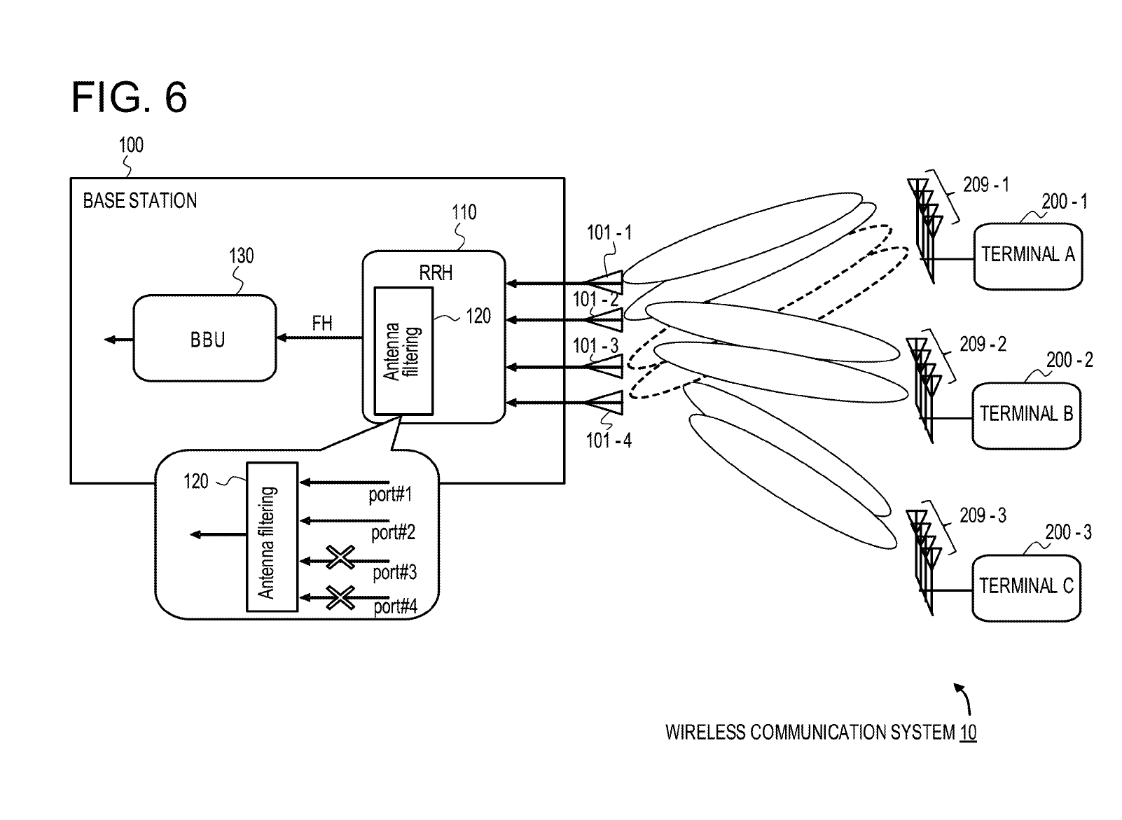

FIG. 6 is a diagram illustrating an example where the antenna filtering 120 of the RRH 110 uniformly performs the antenna filtering. In FIG. 6, an example is illustrated, in which the base station 100 performs a wireless communication with the three terminals 200-1 to 200-3 in an uplink (UL) direction, and an example is illustrated, in which the terminal 200-1 requests layer “4” as the request throughput and each of the terminals 200-2 and 200-3 requests layer “2.”

Further, in the example of FIG. 6, the antenna filtering 120 is set to validate the antenna ports #1 (101-1) and #2 (101-2) and set not to validate the antenna ports #3 (101-3) and #4 (101-4). Therefore, the antenna filtering 120 transmits, for example, the data received by the antennas 101-1 and 101-2 to the BBU 130 and discards, for example, the data received by the antennas 101-3 and 101-4 without transmitting the data to the BBU 130.

In this case, the terminal 200-1 transmits each transmission stream of layer “4” by using the four antennas 209-1, and the base station 100 receives respective transmission streams in the four antennas 101-1 to 101-4.

Therefore, the antenna filtering 120 transmits the data (each transmission stream) received by the antennas 101-1 and 101-2 to the BBU 130 and does not transmit the data received by the antennas 101-3 and 101-4 to the BBU 130. Therefore, although the terminal 200-1 requests layer “4” and transmits the transmission stream for layer “4,” only the transmission stream for layer “2” is transmitted to the BBU 130. As a result, the terminal 200-1 transmits the transmission stream for layer “2” to the base station 100.

Meanwhile, for the terminals 200-2 and 200-3, the transmission streams of layer “2” transmitted from the terminals 200-2 and 200-3 received by the antennas 101-1 and 101-2 are transmitted to the BBU 130 by the antenna filtering 120.

When the terminals 200-1 to 200-3 simultaneously transmit data to the base station 100, the antenna filtering 120 uniformly outputs data for the number of transmissions ports “2” to the FH with respect to transmission data from the terminals 200-1 to 200-3. For this reason, the antenna filtering 120 outputs data for the number of transmission ports “6” (or data for layer “6”) to the FH.

In this manner, when the antenna filtering 120 uniformly performs the antenna filtering on the data transmitted from the terminals 200-1 to 200-3, the antenna filtering 120 may output a predetermined amount of data to the FH. Assuming that the data amount of layer “6″” is the maximum throughput of the FH, data may be output within the range of the maximum throughput by uniformly performing the antenna filtering.

However, it cannot be said that the antenna filtering 120 outputs, for example, data corresponding to the requested throughput from the terminal 200-1 to the FH.

Therefore, in the first embodiment, the base station 100 performs the antenna filtering for each of the terminals 200-1 to 200-3 according to the requested throughput from the terminals 200-1 to 200-3 within the range of the maximum throughput of the FH.

### 2. Example of Performing Antenna Filtering for each Terminal

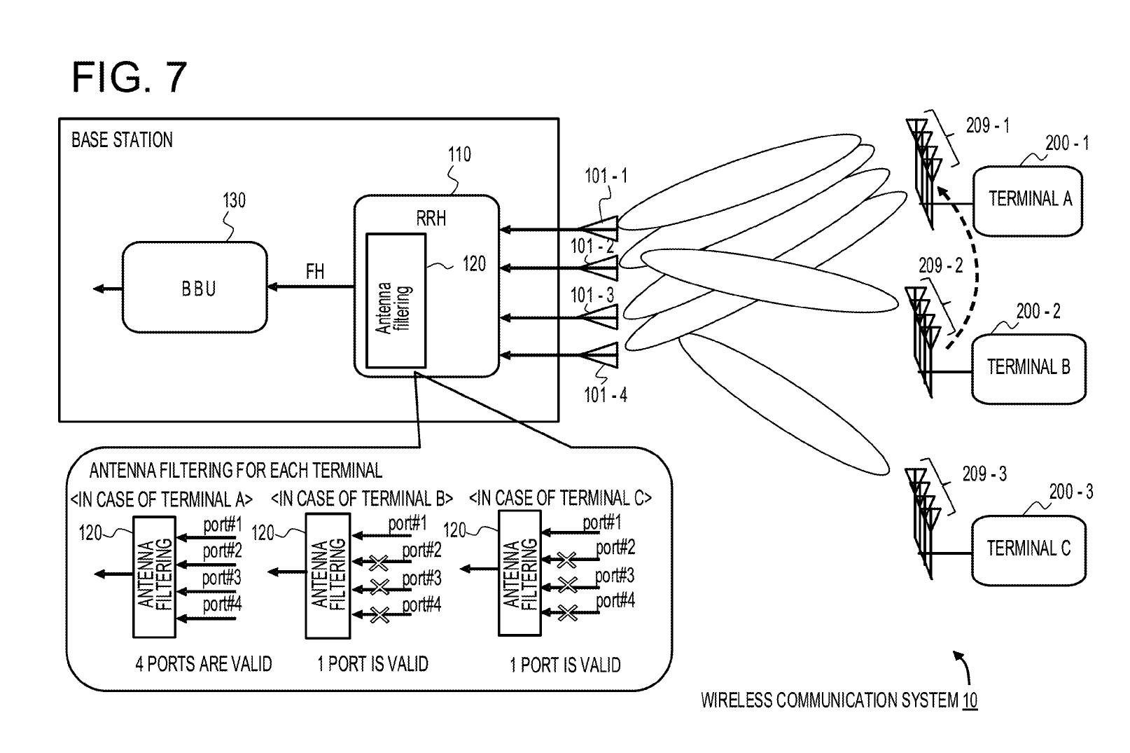

FIG. 7 is a diagram illustrating an example when antenna filtering is performed for each of terminals 200-1 to 200-3.

In the example of FIG. 7, the terminal 200-1 requests layer “4” as the request throughput, and each of the terminals 200-2 and 200-3 requests layer “2” as the request throughput. However, even though the number of layers is reduced to “1,” the terminals 200-2 and 200-3 satisfy the request throughput.

In this case, the terminals 200-2 and 200-3 each have a remainder of layer “1” with respect to the request throughput. Therefore, the base station 100 gives each remaining layer “1” to the terminal 200-1 and sets the number of layers of the terminal 200-1 to “4” to transmit data according to the request throughput of the terminal 200-1.

Then, the antenna filtering 120 validates all of the four antenna ports #1 to #4 (antennas 101-1 to 101-4) for the terminal 200-1 and outputs data received by all of the antennas 101-1 to 101-4 to the FH. Further, the antenna filtering 120 validates one antenna port #1 (antenna 101-1) for the terminals 200-2 and 200-3 and does not validate the other antenna ports #2 to #4 (the antenna 101-2 to 101-4).

In this case, for example, when the terminals 200-1 to 200-3 transmit data to the base station 100 at the same time, “4” layers of the terminal 200-1 and “1” layer of each of the terminals 200-2 and 200-3, that is, data for all “6” layers are output to the FH. The data for “6” layers become data for the same number of layers as the case of FIG. 6.

For example, when the maximum throughput of the FH is “6” layer as in the case of FIG. 6, the antenna filtering 120 may output data within the range of the maximum throughput to the FH.

Moreover, the antenna filtering 120 outputs data to the FH according to the request throughput of the terminal 200-1 and enables the data to be output to the FH according to the request of the terminal 200-1. Therefore, the base station 100 may efficiently utilize the FH.

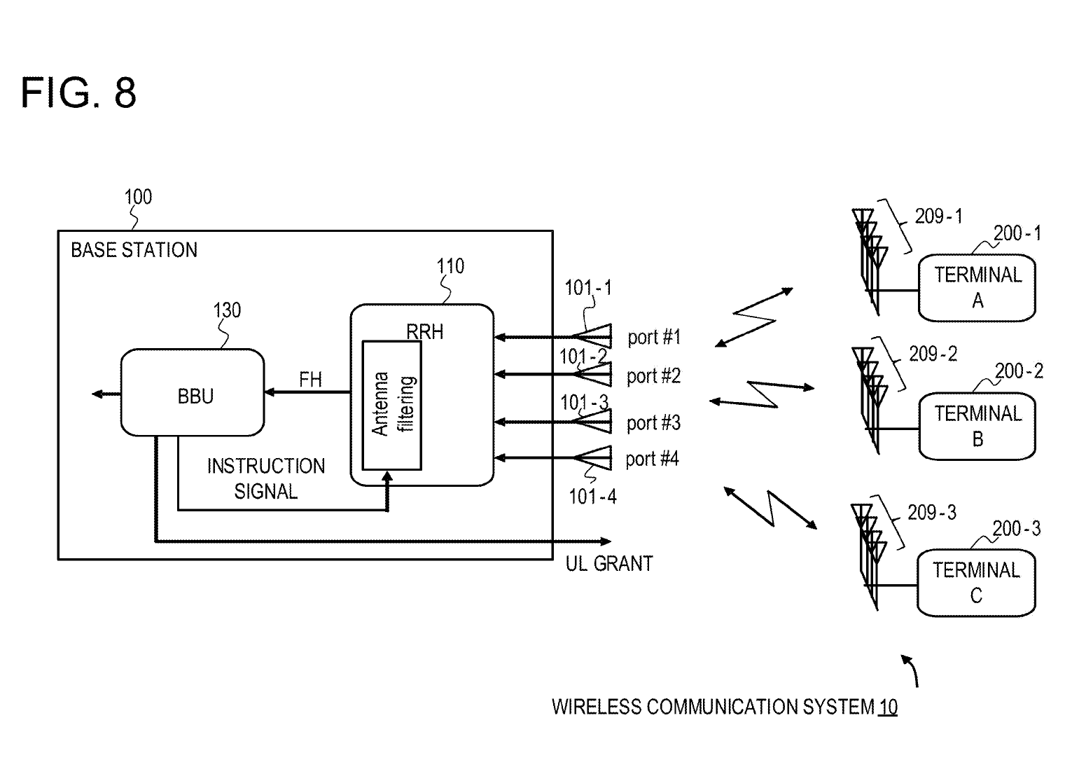

FIG. 8 is a diagram illustrating an example of the antenna filtering. As illustrated in FIG. 8, for each of the terminals 200-1 to 200-3, the BBU 130 transmits an antenna port use instruction signal indicating a valid antenna port to the RRH 110. The antenna filtering 120 of the RRH 110 validates all or some of the antenna ports #1 to #4 for each of the terminals 200-1 to 200-3 according to the antenna port use instruction signal. Thereafter, the BBU 130 transmits the UL grant indicating the scheduling result to the terminals 200-1 to 200-3.

### 3. Operation Example

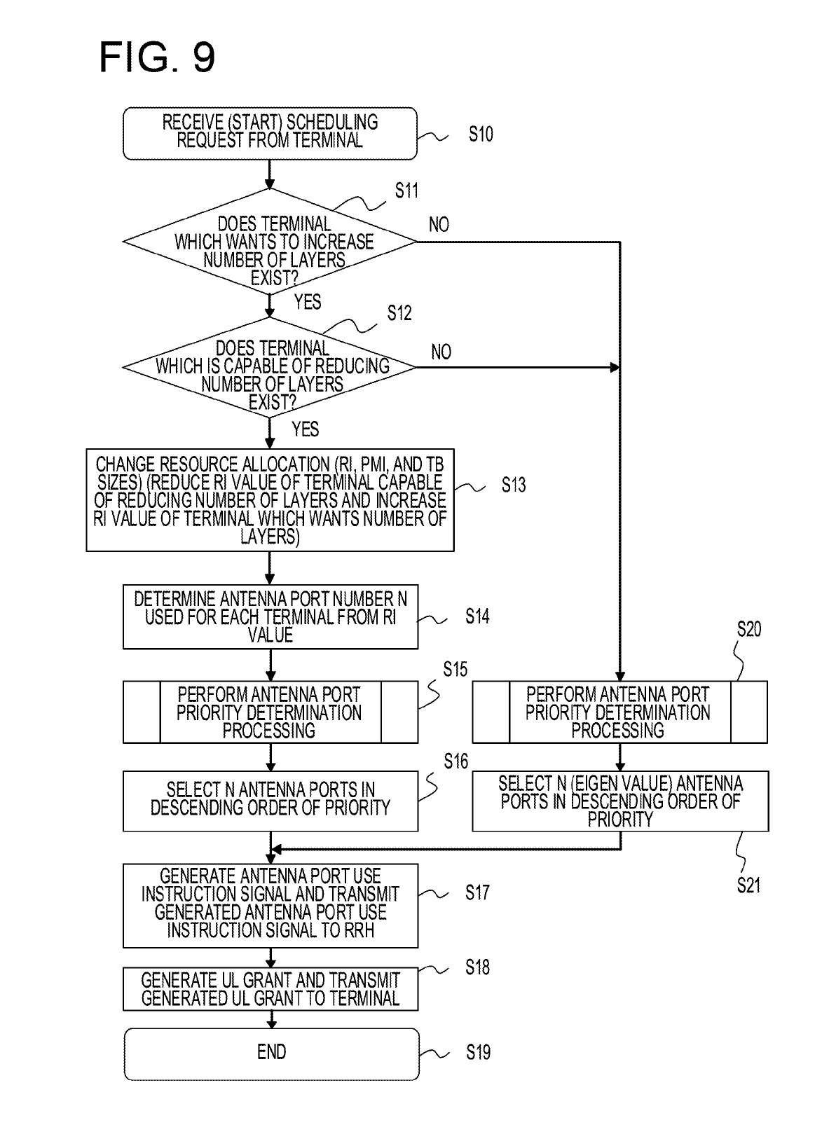

FIG. 9 is a flowchart illustrating an operation example in the first embodiment. The flowchart is, for example, the processing performed by the BBU 130.

Upon receiving the scheduling request from the terminal 200, the BBU 130 starts the processing (S10). For example, the scheduler 138 starts the processing when receiving the scheduling request from the decoding processing unit 135.

Next, the BBU 130 determines whether there is a terminal 200 that wants to increase the number of layers (S11). When it is determined that there is the terminal 200 that wants to increase the number of layers (“Yes” in S11), the BBU 130 determines whether there is a terminal 200 that may reduce the number of layers (S12).

For example, the scheduler 138 performs the following processing. That is, the scheduler 138 extracts the number of request layers as the request throughput from the scheduling request transmitted from each of the terminals 200-1 to 200-3. Then, the scheduler 138 compares the number of request layers of each of the terminals 200-1 to 200-3 with a reference value and when the number of request layers is larger than the reference value, the scheduler 138 determines that “there is the terminal that wants to increase the number of layers” (“Yes” in S11). Meanwhile, when the number of request layers is smaller than the reference value, the scheduler 138 determines that “there is the terminal that wants to reduce the number of layers” (“Yes” in S12).

The reference value may be, for example, a value obtained by dividing the maximum throughput of the FH by the number of all terminals 200-1 to 200-3 to be scheduled. In the example of FIG. 6, when the maximum throughput of the FH is “6” layers, the maximum throughput is divided by “3” which is the number of terminals 200-1 to 200-3, and “2” layers become the reference value. In this case, when the terminal 200-1 requests “4” layers, since the terminal 200-1 requests the number of layers larger than the reference value, the terminal 200-1 is “the terminal that wants to increase the number of layers” (“Yes” in S11). Meanwhile, when the request throughput of the terminals 200-2 and 200-3 is “1,” the request throughput is smaller than the reference value, so the terminals 200-2 and 200-3 become “the terminal that wants to reduce the number of layers” (“Yes” in S12).

Further, the reference value may be, for example, the RI value which the scheduler 138 allocates to each of the terminals 200-1 to 200-3 in scheduling immediately before the scheduling. Alternatively, the reference value may be, for example, a predetermined numerical value (e.g., “2”).

For example, the scheduler 138 may store the reference value in the memory 160 and compare the number of layers included in the scheduling request with the reference value to make a determination.

Specifically, the scheduling request includes, for example, the RI value. The RI value becomes, for example, the number of layers requested by the terminal 200. The RI value and the number of layers have, for example, the same value. Hereinafter, the RI value and the number of layers may be used without distinction.

Next, the BBU 130 changes the resource allocation (S13). The change indicates that the value of the request throughput (=request RI value) included in the scheduling request transmitted from each of the terminals 200-1 to 200-3 is changed. For example, the scheduler 138 reduces the RI values of the terminals 200-2 and 200-3 capable of reducing the number of layers and increases the RI value of the terminal 200-1 which wants to increase the number of layers. In the example of FIG. 6, the scheduler 138 changes the RI values of the terminals 200-2 and 200-3 to “1” and changes the RI value of the terminal 200-1 to “4” according to the request.

Next, the BBU 130 determines the number N (N is an integer of 1 or more) of antenna ports to be used for each terminal 200 from the RI value (S14). For example, the BBU 130 performs the following processing.

That is, the scheduler 138 outputs the RI value (or the number of layers) of each terminals 200-1 to 200-3 after the change to the antenna port use instruction signal generation unit 140. Based on the RI value (or the number of layers), the antenna port use instruction signal generation unit 140 determines the antenna port number N that is validated in the wireless communication with the terminals 200-1 to 200-3 for each of the terminals 200-1 to 200-3 based on the RI value (or the number of layers). In the example of FIG. 6, since the RI value of the terminal 200-1 is “4,” the antenna port use instruction signal generation unit 140 determines the number of antenna ports to be set to “4” and since the RI value of each of the terminals 200-2 and 200-3 is “2,” the antenna port use instruction signal generation unit 140 determines the number of antenna ports to be set to “2.”

Next, the BBU 130 performs an antenna port priority determination processing (S15).

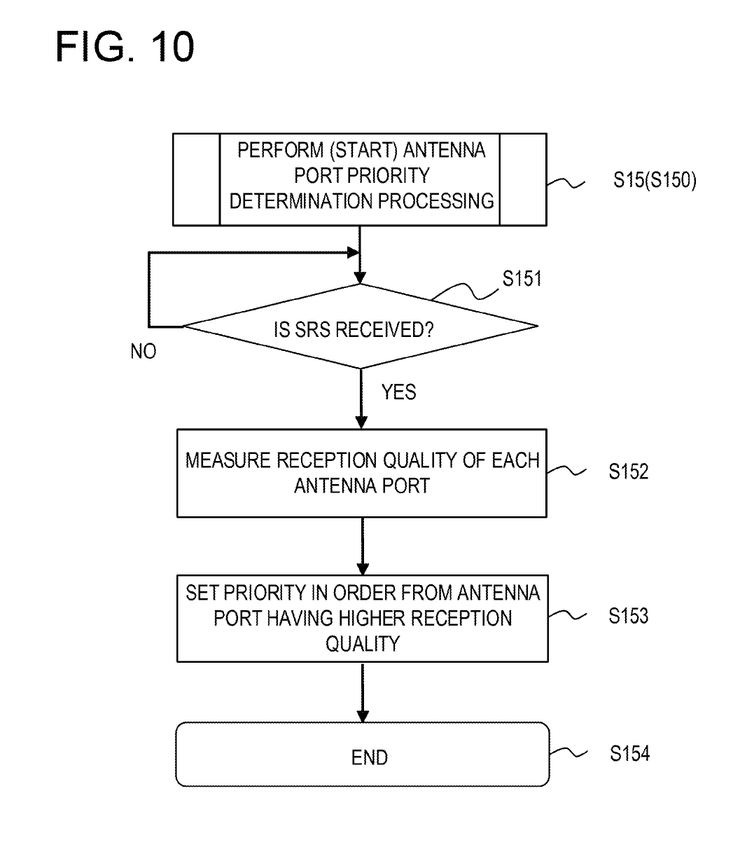

FIG. 10 is a flowchart illustrating an operation example of the antenna port priority determination processing.

When the antenna port priority determination processing is started (S150), the BBU 130 determines whether the SRS has been received (S151). For example, it is determined whether the SRS reception unit 136 has received the SRS.

When it is determined that the SRS has been received (“Yes” in S151), the BBU 130 measures the reception quality of each of the antenna ports #1 to #4 (S152). For example, the channel estimation unit 137 calculates a channel estimation value for each of the antennas 101-1 to 101-4 and measures the reception quality (CQI or CSI) of each of the antennas 101-1 to 101-4 based on the calculated channel estimation value.

Next, the BBU 130 sets priorities in order from antenna ports #1 to #4 with a good reception quality (S153). For example, the BBU 130 performs the following processing.

That is, the scheduler 138 receives the reception quality of each of the antenna ports #1 to #4 from the channel estimation unit 137 and outputs the reception quality to the antenna port use instruction signal generation unit 140. The antenna port use instruction signal generation unit 140 ranks the antenna ports #1 to #4 in a descending order of the reception quality. In the example of FIG. 6, the antenna port use instruction signal generation unit 140 sets the antenna port #1 (or the antenna 101-1) as the antenna port having the highest priority, and the antenna ports #2 to #4 (or the antennas 101-2 to 101-4) are ranked in order.

Next, the BBU 130 terminates the antenna port priority determination processing (S154).

Meanwhile, when it is determined that the SRS has not been received (“No” in S151), the BBU 130 waits until the SRS is received.

Referring back to FIG. 8, next, the BBU 130 selects N antenna ports in the descending order of the priority (S16). For example, the antenna port use instruction signal generation unit 140 sequentially selects the number of antenna ports # 1 to #4 (or the antennas 101-1 to 101-4) equal in number to the number of antenna ports N (S14) in the descending order of the priority for each terminal 200. In the example of FIG. 6, the antenna port use instruction signal generation unit 140 selects all the antenna ports of the antennas 101-1 to 101-4 for the terminal 200-1 and selects the antenna 101-1 having the highest priority with respect to the terminals 200-2 and 200-3.

Next, the BBU 130 generates an antenna port use instruction signal and transmits the generated antenna port use instruction signal to the RRH 110 (S17). For example, the antenna port use instruction signal generation unit 140 generates an antenna port use instruction signal indicating the selected antenna port for each of the terminals 200-1 to 200-3 and transmits the generated antenna port use instruction signal to the RRH 110 (S18).

Next, the BBU 130 generates a UL grant and transmits the generated UL grant to the terminals 200-1 to 200-3 (S18). For example, the scheduler 138 outputs the scheduling result to the UL grant generation unit 139, and the UL grant generation unit 139 generates a UL grant signal including the scheduling result and transmits the generated UL grant signal to the terminals 200-1 to 200-3. The scheduler 138 outputs the RI value (S13) determined by the resource allocation to the antenna port use instruction signal generation unit 140, and then, outputs the scheduling result to the UL grant generation unit 139. As a result, for example, after the antenna port use instruction signal is transmitted from the BBU 130 to the RRH 110, the UL grant signal is transmitted from the BBU 130 to the terminal 200 via the RRH 110.

Then, the BBU 130 terminates a series of processing (S19).

Meanwhile, when the terminal 200 that wants to increase the number of layers does not exist (“No” in S11) or when the terminal capable of reducing the number of layers does not exist (“No” in S12) even though the terminal 200 that wants to increase the number of layers exists (“Yes” in S11), the BBU 130 performs the antenna port priority determination processing (S20). An operation example of the antenna port priority determination processing is illustrated in the flowchart illustrated in FIG. 10, as in S15.

In this case, the RI value requested by the terminal 200 is smaller than the reference value (“No” in S11) or even when the requested RI value is higher, the RI values requested by other terminals 200-2 and 200-3 are not lower values (“No” in S12). Therefore, the scheduler 138 does not output the changed RI value to the antenna port use instruction signal generation unit 140, but outputs, for example, a fact that there is no change in the RI value. The antenna port use instruction signal generation unit 140 that has received the fact performs the antenna port priority determination processing (S20). Further, the scheduler 138 performs a scheduling without changing the RI value, for example, by considering the maximum throughput of the FH, the scheduler 138 allocates a predetermined value (e.g., an Eigen value “n” (“n” is an integer of 1 or more)) as the RI value of each of the terminals 200-1 to 200-3.

Referring back to FIG. 9, next, the BBU 130 selects “n” antenna ports #1 to #4 in the descending order of the priority (S21). For example, the antenna port use instruction signal generation unit 140 reads the Eigen value “n” from, for example, an internal memory and selects the “n” antenna ports #1 to #4 having the high priority with respect to the antenna port which is first given in the descending order of the reception quality with respect to each of the terminals 200-1 to 200-3.

Then, the BBU 130 performs processing from S17. In this case as well, the scheduler 138, for example, outputs to the antenna port use instruction signal generation unit 140 the fact that there is no change in the RI value (“No” in S11 and “No” in S12), and then, outputs the scheduling result to the UL grant generation unit 139 (S18).

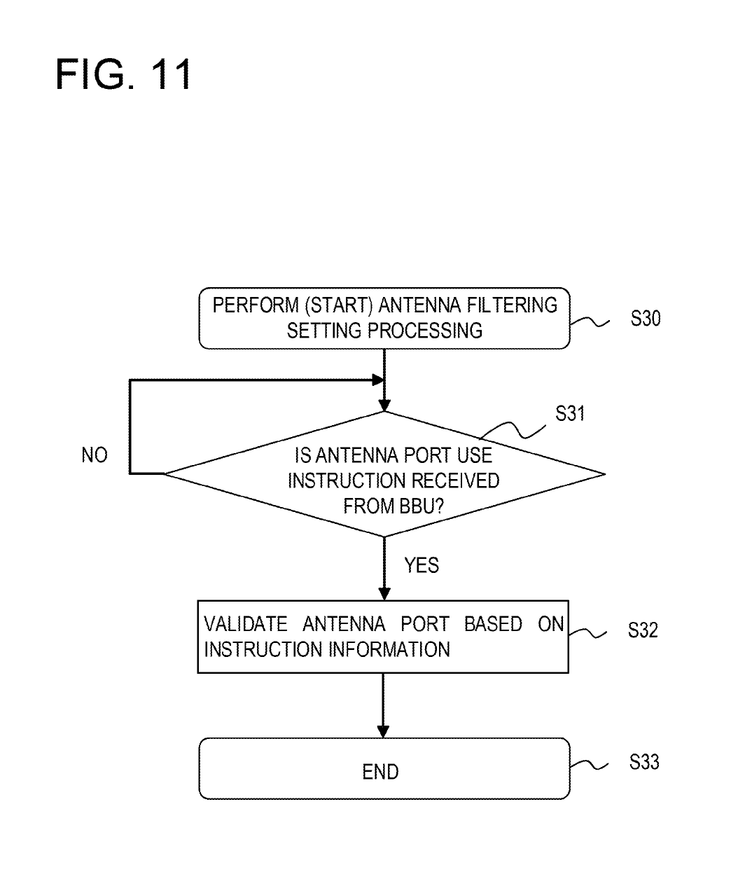

Next, the antenna filtering setting processing performed in the RRH 110 that has received the antenna port use instruction signal will be described. FIG. 11 is a flowchart illustrating an example of the processing (S30).

When the antenna filtering setting processing is started (S30), the RRH 110 determines whether the antenna port use instruction signal has been received from the BBU 130 (S31). For example, it is determined whether the antenna port use instruction signal reception unit 117 has received the antenna port use instruction signal transmitted from the BBU 130 via the FHIF 116.

When it is determined that the antenna port use instruction signal has not been received (“No” in S31), the RRH 110 waits until the antenna port use instruction signal is received, and when it is determined that the antenna port use instruction signal has been received (“Yes” in S31), based on the instruction information, the RRH 110 notifies the terminal 200 validates the indicated antenna port for each terminal 200 (S32). For example, the antenna port use instruction signal reception unit 117 receives the antenna port use instruction signal, and the antenna filtering setting unit 118 generates the instruction information from the antenna port use instruction signal. In addition, the antenna filtering processing unit 115 validates the instructed antenna port for each terminal 200 according to the instruction information.

Then, the RRH 110 terminates the antenna filtering setting processing (S33).

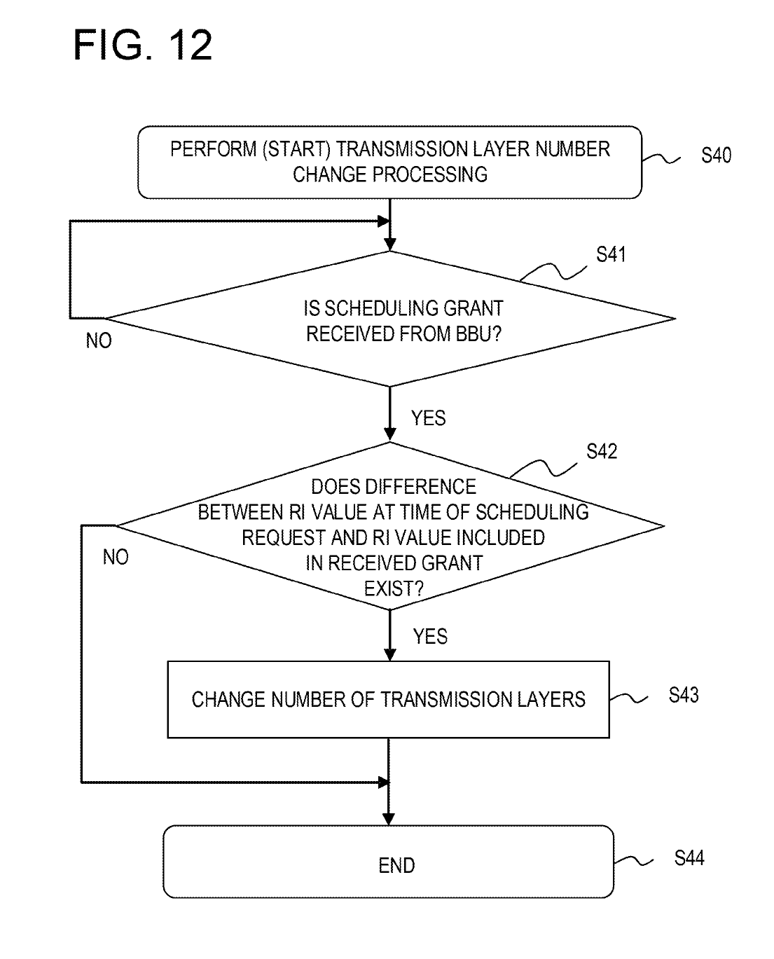

Next, a transmission layer changing processing performed in the terminal 200 that has received the UL grant signal will be described. FIG. 12 is a flowchart illustrating an example of the processing.

When the transmission layer number change processing is received (S40), the terminal 200 determines whether the UL grant signal has been received from the BBU 130 (S41), and when it is determined that the UL grant signal has not been received (“No” in S41), the terminal 200 waits until the UL grant signal is received. For example, it is determined whether the SRS reception unit 212 has received the UL grant signal.

Meanwhile, when it is determined that the UL grant signal has been received (“Yes” in S41), the terminal 200 determines whether there is a difference between the RI value at the time of the scheduling request and the RI value included in the received grant (S42). For example, the terminal 200 performs the following processing.

That is, upon receiving the UL grant signal, the UL grant reception unit 212 outputs the RI value included in the UL grant signal to the RI value comparison processing unit 213. Since the RI value comparison processing unit 213 receives the request RI value at the time of the scheduling request from the scheduling request signal generation unit 211, the RI value comparison processing unit 213 compares the requested RI value with the RI value received from the UL grant reception unit 212 to determine whether there is the difference.

When it is determined that there is the difference (“Yes” in S42), the terminal 200 changes the number of transmission layers to the RI value included in the UL grant signal (S43). For example, the terminal 200 performs the following processing.

That is, the RI value comparison processing unit 213 compares the requested RI value received from the scheduling request signal generation unit 211 with the RI value received from the UL grant reception unit 212, and when the RI value comparison processing unit 213 determines that both RI values are not the same value but there is a difference between both RI values, the RI value comparison processing unit 213 outputs two RI values to the layer number change processing unit 214. The layer number change processing unit 214 sets the RI value received from the UL grant reception unit 212 as the changed RI value and outputs the RI value to the layer mapping unit 203. The layer mapping unit 203 maps the modulation signal to each layer according to the changed RI value.

Then, the terminal 200 terminates a series of processing.

Meanwhile, when it is determined that there is no difference between the two RI values (“No” in S42), that is, when the RI value is allocated as requested by the requested RI value, the terminal 200 terminates the transmission player number change processing without changing the number of transmission layers (S44). For example, when the requested RI value received from the scheduling request signal generation unit 211 and the RI value received from the UL grant reception unit 212 have the same value, the RI value comparison processing unit 213 outputs the RI value received from the UL grant reception unit 212 to the layer mapping unit 203.

### 4. Example of Numerical Value

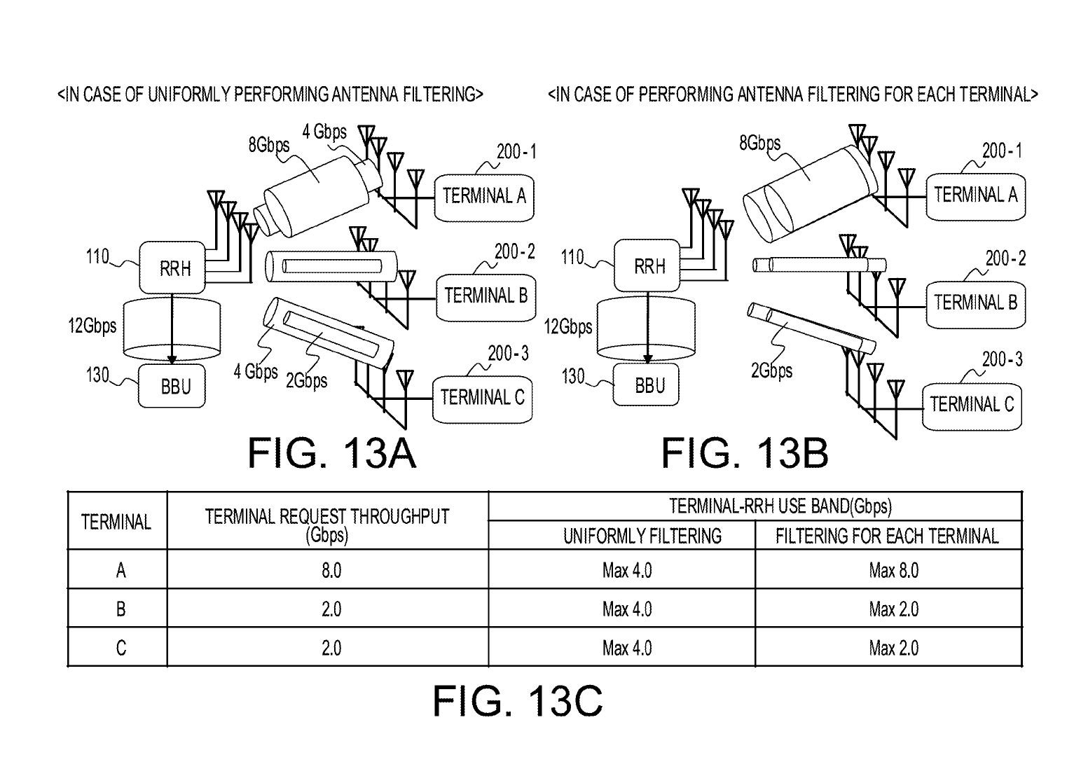

FIGS. 13A to 13C are diagrams illustrating an example of a numerical value. Among the diagrams, FIG. 13A illustrates an example where the antenna filtering is performed uniformly, FIG. 13B illustrates an example of performing the antenna filtering for each terminal 200, and FIG. 13C illustrates an example of a relationship between the request throughput and a use band of the FH. In this example, a bit rate is used as the request throughput.

As illustrated in FIG. 13A, it is considered that the terminal 200-1 requests “8 Gbps” as the request throughput, and the terminals 200-2 and 200-3 request “2 Gbps.” Further, the maximum throughput of the FH is “12 Gbps.” In the example of FIG. 13A, the antenna filtering 120 uniformly performs the antenna filtering in “4 Gbps” for all of the terminals 200-1 to 200-3.

In this case, as illustrated in FIG. 13A, even when the terminal 200-1 transmits data of “8 Gbps” by receiving an allocation of “8 Gbps,” the RRH 110 outputs data of “4 Gbps” to the FH. Meanwhile, when each of the terminals 200-2 and 200-3 transmits data of “2 Gbps” by receiving an allocation of “2 Gbps,” the RRH 110 outputs the data of “2 Gbps” to the FH. The data of “8 Gbps” is all transmitted to the FH.

In this case, the data of the request throughput “8 Gbps” is not output to the FH with respect to the terminal 200-1, while the data of the request throughput “2 Gbps” is output to the FH with respect to the terminals 200-2 and 200-3, but there is a margin up to “12 Gbps,” which is the maximum throughput of the FH.

Even in the second embodiment, as illustrated in FIG. 13B, surplus throughput “1 Gbps” of the terminals 200-2 and 200-3 is allocated to the terminal 200-1. Therefore, with regard to the terminal 200-1, the data of the request throughput “8 Gbps” may be output to the FH by the antenna filtering 120. In this case, with respect to each of the terminals 200-2 and 200-3, the data of the request throughput “2 Gbps” is outputted to the FH.

In the example of FIG. 13B, the data of “12 Gbps” is transmitted in the FH in total and is within the range of the maximum throughput “12 Gbps.”

In FIG. 13C, the numerical values illustrated in FIGS. 13A and 13B are integrated in a table. As illustrated in FIG. 13C, when the antenna filtering is uniformly performed for the use band of the FH, it is possible to filter up to “4 Gbps” for each of the terminals 200-1 to 200-3. Meanwhile, by the filtering for each terminal, it is possible to perform filtering up to “8 Gbps” for the terminal 200-1 and it is possible to perform filtering up to “2 Gbps” for the terminals 200-2 and 200-3. Therefore, in the first embodiment, it is possible to perform an antenna filtering for each terminal 200 within the range of the maximum throughput of the FH, while it is possible to output to the FH in the request throughput of the terminal 200-1 and it is possible to efficiently use the FH.

### Other Embodiments

In the first embodiment, an example in which one RRH 110 is connected to the BBU 130 is described. For example, a plurality of RRHs 110 may be connected to one BBU 130.

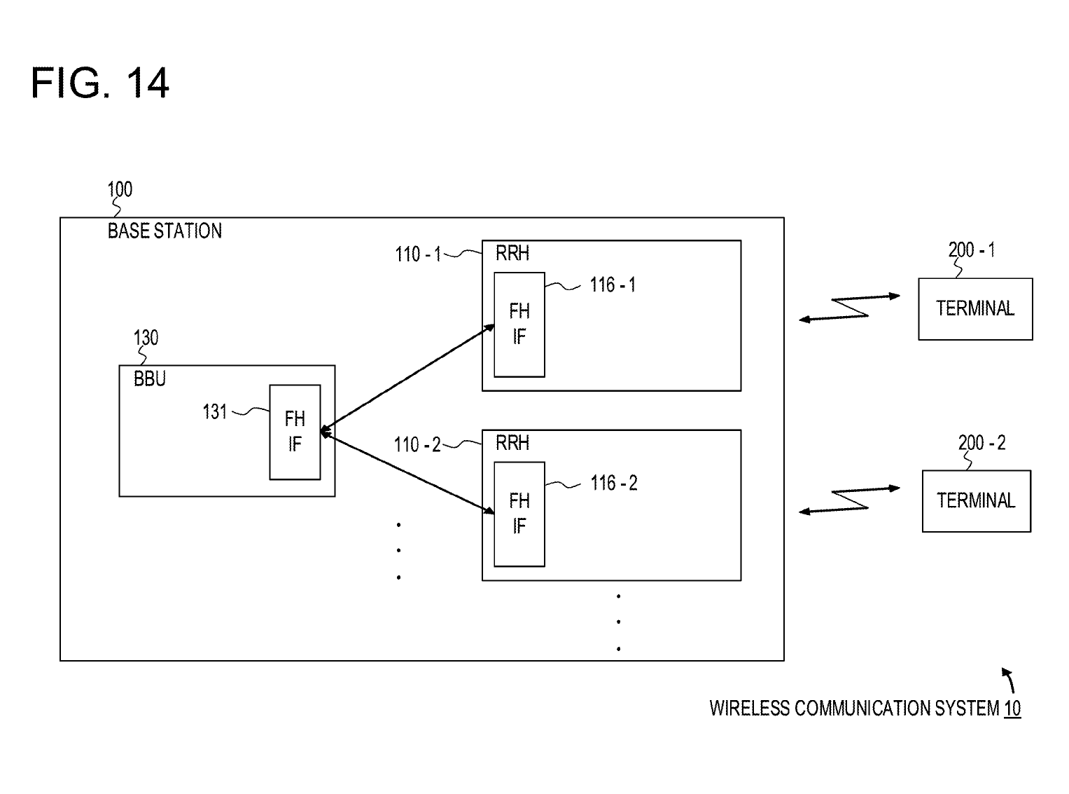

FIG. 14 is a diagram illustrating an example of a configuration of the base station 100 in such a case. The RRHs 110-1, 110-2, . . . is connected to the BBU 130 via the FHIFs 116-1, 116-2, . . . , respectively. In this case, the antenna port use instruction signal generation unit 140 of the BBU 130 generates the antenna port use instruction signal in each of the RRHs 110-1, 110-2, . . . and transmits the generated antenna port use instruction signal to each of the RRHs 110-1, 110-2, . . . via the FHIF 131. Each of the RRHs 110-1, 110-2, . . . may perform the antenna filtering by validating the antenna port for each of the terminals 200-1 and 200-2 according to the antenna port use instruction signal.

Further, in the first embodiment, the example of the configuration based on LTE called the BBU 130 and the RRH 110 is described. For example, even with the configuration of the base station 100 being considered in 5G, the first embodiment may be implemented.

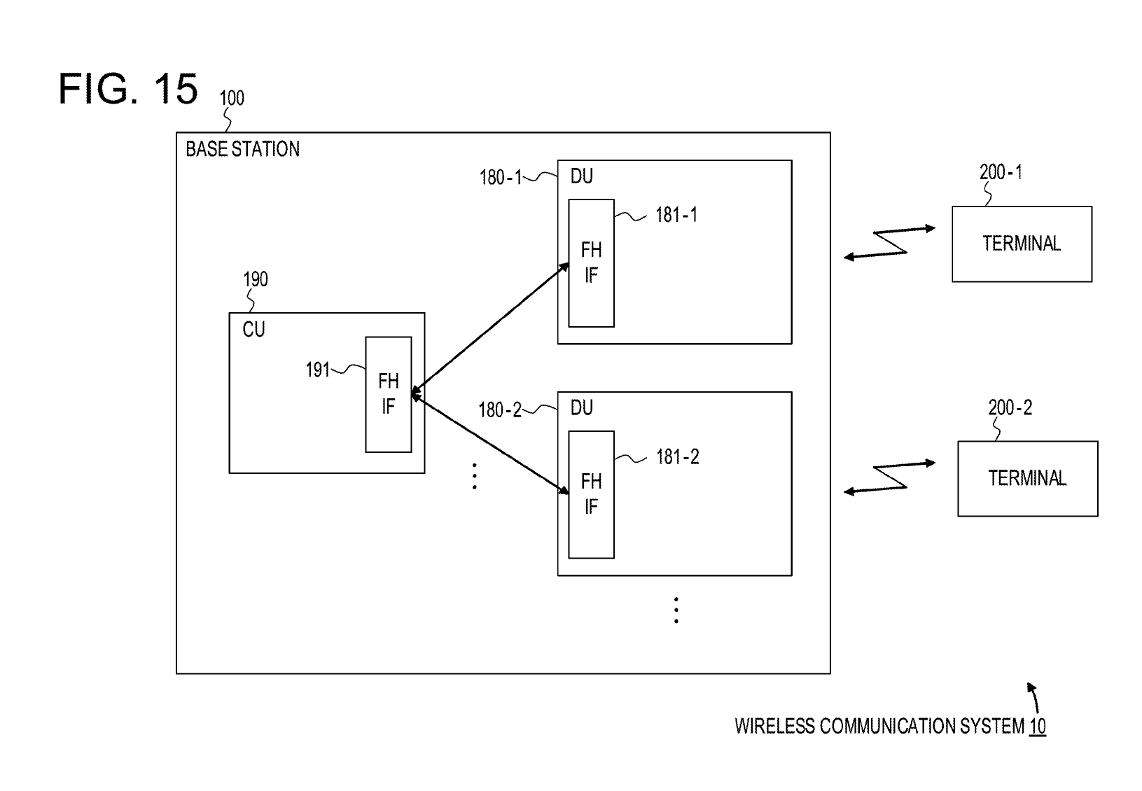

FIG. 15 illustrates an example of a configuration of the base station 100 in such a case. The base station 100 includes a CPU 190 and one or a plurality of DUs 180-1, 180-2, . . . . For example, the CPU 190 may correspond to the BBU 130 of the first embodiment, and the DU 180-1 may correspond to the RRH 110 of the first embodiment. Scheduling is performed in the CU 190 to include the antenna port use instruction signal generation unit 140, and the antenna port use instruction signal generation unit 140 generates the antenna port use instruction signal. The antenna port use instruction signal is transmitted to each of the DUs 180-1, 180-2, . . . via the FHIF 191 similarly to, for example, FIG. 14. In addition, each of the DUs 180-1, 180-2, . . . may perform the antenna filtering by validating the antenna port for each of the terminals 200-1 and 200-2 according to the antenna port use instruction signal. For example, the blocks included in the CU 190 include all the blocks included in the BBU 130 illustrated in FIG. 2 and the DUs 180-1, 180-2, . . . also include all the blocks included in the RRH 110 illustrated in, for example, FIG. 2.

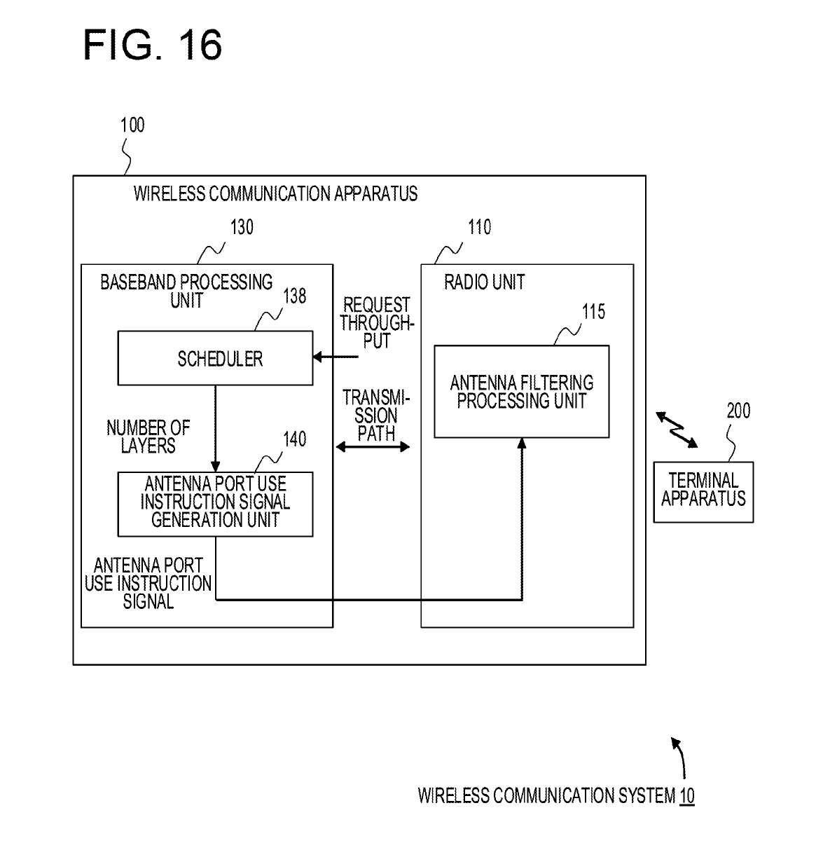

FIG. 16 is a diagram illustrating an example of a configuration of the wireless communication system 10. The wireless communication system 10 includes a wireless communication apparatus 100 and a terminal apparatus 200.

Further, the wireless communication apparatus 100 corresponds to, for example, the base station 100 in the first embodiment.

The wireless communication apparatus 100 includes a baseband processing unit 130 and a radio unit 110. Further, the baseband processing unit 130 includes a scheduler 138 and an antenna port use instruction signal generation unit 140. In addition, the radio unit 110 includes an antenna filtering processing unit 115.

The baseband processing unit 130 corresponds to, for example, the BBU 130 of the first embodiment. Further, the radio unit 110 corresponds, for example, to the RRH 110 of the first embodiment.

The radio unit 110 receives a radio signal transmitted from the terminal apparatus 200 and converts the received radio signal into a baseband signal. The baseband processing unit 130 performs the processing on the baseband signal.

The scheduler 138 determines the number of layers of the terminal apparatus 200 according to request throughput of the terminal apparatus 200, which is included in the baseband signal within a range of maximum throughput in a transmission path between the radio unit 110 and the baseband processing unit 130. Further, the transmission path is sometimes referred to as, for example, FH.

The antenna port use instruction signal generation unit generates an antenna port use instruction signal indicating an antenna port to be used for wireless communication with the terminal apparatus 200 based on the number of layers.

The antenna filtering processing unit 115 performs the antenna filtering for each terminal apparatus 200 with respect to the baseband signal transmitted from the terminal apparatus 200 according to an antenna port use instruction signal.

As described above, the baseband processing unit 130 determines the number of layers of the terminal apparatus 200 according to request throughput of the terminal apparatus 200 within a range of maximum throughput in a transmission path between the radio unit 110 and the baseband processing unit 130. In addition, based on the number of layers, the baseband processing unit 130 transmits an antenna port use instruction signal indicating which antenna port is to be used to the radio unit 110.

Therefore, in the radio unit 110, it is also possible to perform the antenna filtering according to the request throughput of the terminal apparatus 200 within the range of the maximum throughput of the transmission path, and similarly to the case where antenna filtering is performed uniformly, within the range of the maximum throughput of the transmission path, so that data may be transmitted.

In addition, compared to the case where the antenna filtering is performed uniformly, the radio unit 110 may also transmit data on the transmission path according to the request throughput of the terminal apparatus 200.

As described above, in the wireless communication apparatus 100, it is possible to efficiently use the transmission path between the radio unit 110 and the baseband processing unit 130.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus comprising:
a radio unit configured to receive a radio signal transmitted from a terminal apparatus and convert the received radio signal into a baseband signal;
a memory; and
a processor coupled to the memory and the processor configured to:
determine a number of layers of the terminal apparatus according to request throughput of the terminal apparatus included in the baseband signal, within a range of maximum throughput in a transmission path between the radio unit and a baseband processing unit configured to include the memory and the processor, and
generate an instruction signal for indicating an antenna port used in a wireless communication with the terminal apparatus, based on the number of layers,
wherein the radio unit performs antenna filtering of the baseband signal transmitted from the terminal apparatus according to the instruction signal.

2. The wireless communication apparatus according to claim 1, wherein
when there is a first terminal apparatus which requests a first layer number larger than a reference value and there is a second terminal apparatus which requests a second layer number smaller than the reference value in the terminal apparatus,
the processor is configured to determine the number of layers of the first terminal apparatus and the number of layers of the second terminal apparatus as the first layer number and the second layer number, respectively, within the range of the maximum throughput.

3. The wireless communication apparatus according to claim 2, wherein the reference value is a value acquired by dividing the maximum throughput in the transmission path by a number of terminal apparatuses in which scheduling processing is carried out.

4. The wireless communication apparatus according to claim 1, wherein the processor is configured to:
determine a number of antenna ports for the terminal apparatus, based on the number of layers of the terminal apparatus, and
generate the instruction signal, based on the determined number of antenna ports.

5. The wireless communication apparatus according to claim 4, wherein the processor is further configured to:
estimate a reception quality for each of the antenna ports for the terminal apparatus, based on a reference signal transmitted from the terminal apparatus;
select an antenna port of the number of antenna ports in a descending order of the reception quality for the terminal apparatus; and
generate the instruction signal for indicating the selected antenna port.

6. The wireless communication apparatus according to claim 1, wherein the processor is further configured to:
generate an uplink grant signal for indicating a result of scheduling processing.

7. The wireless communication apparatus according to claim 2, wherein the processor is configured to
set the number of layers of the terminal apparatus as predetermined n, wherein n is an integer of 1 or more, when the first terminal apparatus does not exist, or when the first terminal apparatus exists but the second terminal apparatus does not exist, and
generate the instruction signal for indicating n antenna ports.

8. The wireless communication apparatus according to claim 1, wherein the number of layers is a rank indicator (RI) value.

9. The wireless communication apparatus according to claim 1, wherein the radio unit is a distributed unit (DU) and the baseband processing unit is a central unit (CU).

10. An antenna filtering method for a wireless communication apparatus including a radio unit configured to receive a radio signal transmitted from a terminal apparatus and convert the received radio signal into a baseband signal and a baseband processing unit configured to include a processor so as to process the baseband signal, the antenna filtering method comprising:
determining a number of layers of the terminal apparatus according to request throughput of the terminal apparatus included in the baseband signal, within a range of maximum throughput in a transmission path between the radio unit and the baseband processing unit, by the processor;
generating an instruction signal for indicating an antenna port used in a wireless communication with the terminal apparatus, based on the number of layers, by the processor; and
performing antenna filtering of the baseband signal transmitted from the terminal apparatus according to the instruction signal, by the radio unit.
